(19) United States
(12) Patent Application Publication
(10) Pub. No.: US 2006/0256982 A1
(43) Pub. Date: Nov. 16, 2006

(54) SOUND MIXING SYSTEM AND METHOD

(75) Inventor: Michael Paul Stavrou, Cremorne (AU)

Correspondence Address: MILES & STOCKBRIDGE PC, 1751 PINNACLE DRIVE, SUITE 500, MCLEAN, VA, 22102-3833, US

(73) Assignee: Flux Research Pty. Ltd.

(21) Appl. No.: 11/383,637

(22) Filed: May 16, 2006

(30) Foreign Application Priority Data
May 16, 2005 (AU) 205902490

(51) Int. Cl. H04B 1/00

(52) U.S. Cl. 381/119

(57) ABSTRACT

A method and system are disclosed for adjusting the gain applied to an audio track during sound mixing, including (i) at a first time during said track commencing a gain adjustment, (ii) maintaining a possible gain adjustment until a second time later than said first time and during said track, and (iii) at said second time triggering a retrospective gain level setting mode, whereby the gain level from said first time to at least said second time is set to the level applying at said second time.

### BACKGROUND OF THE INVENTION

The present invention relates to the sound mixing of audio tracks. Although the present invention is primarily concerned with sound mixing for songs, it is not restricted thereto and is also applicable to the sound mixing of audio tracks of movies, video sequences, and the like.

Sound mixing is required to balance the relative volumes of a plurality of recorded tracks so as to produce a final output. Typically a song, for example, is recorded using several microphones which each produce an (unadjusted) audio track. Each microphone may record (or record predominately) the sounds made by an individual performer or instrument. If the length of a song is, say, three minutes in total duration, it is not uncommon for a sound engineer to take up to twelve hours to mix the individual tracks satisfactorily.

For example, the sound engineer must listen to an individual track and decide on an appropriate gain level (which can include either attenuation or amplification of the original recorded signal). Once this level has been decided upon, the track must be effectively re-wound and commenced from the beginning in order that the appropriate gain level apply from the beginning of the track. Furthermore, the sound engineer normally makes adjustment to the gain level at any time during the track. Thus if the sound engineer commences an adjustment at a time of, say 1:34 (ie one minute thirty four seconds from commencement) and it takes the sound engineer until 1:45 to be satisfied that the gain level is now appropriate to the particular passage, then the track must be re-wound back to 1:34 in order that the desired gain level be applied to the eleven second passage of play from 1:34 to 1:45. Such a need makes a substantial contribution to the time demanding nature of the sound mixing engineer's activities.

The object of the present invention is to substantially reduce, or at least ameliorate, the abovementioned disadvantage by the provision of a sound mixing system and method which is less time consuming.

### SUMMARY OF THE INVENTION

In accordance with a first aspect of the present invention there is disclosed a method of adjusting the gain applied to an audio track during sound mixing, said method comprising:

(i) at a first time during said track commencing a gain adjustment,

(ii) maintaining a possible gain adjustment until a second time later than said first time and during said track, and

(iii) at said second time triggering a retrospective gain level setting mode, whereby the gain level from said first time to at least said second time is set to the level applying at said second time.

In accordance with a second aspect of the invention, there is disclosed a sound mixing system for adjusting the gain applied to an audio track during sound mixing, said system comprising an unadjusted audio track storage section having an output connected to a gain adjuster, a detector connected with said gain adjuster to detect commencement of gain adjustment at a first time, and to detect maintenance of possible gain adjustment until a second time and an actuator operated at said second time and connected with said gain adjuster to retrospectively set the gain thereof to the level applying at said second time from said first time until at least said second time.

In accordance with a third aspect of the present invention there is disclosed a sound mixing system for adjusting the gain applied to an audio track during sound mixing, said system comprising an unadjusted audio track storage means having an output connected to a gain adjustment means, detection means connected with said gain adjustment means to detect commencement of gain adjustment at a first time, and to detect maintenance of possible gain adjustment until a second time, actuation means operated at said second time and connected with said gain adjustment means to retrospectively set the gain thereof to the level applying at said second time from said first time until at least said second time.

### DETAILED DESCRIPTION OF AN EMBODIMENT OF THE INVENTION

A preferred embodiment of the present invention will now be described with reference to the drawings in which:

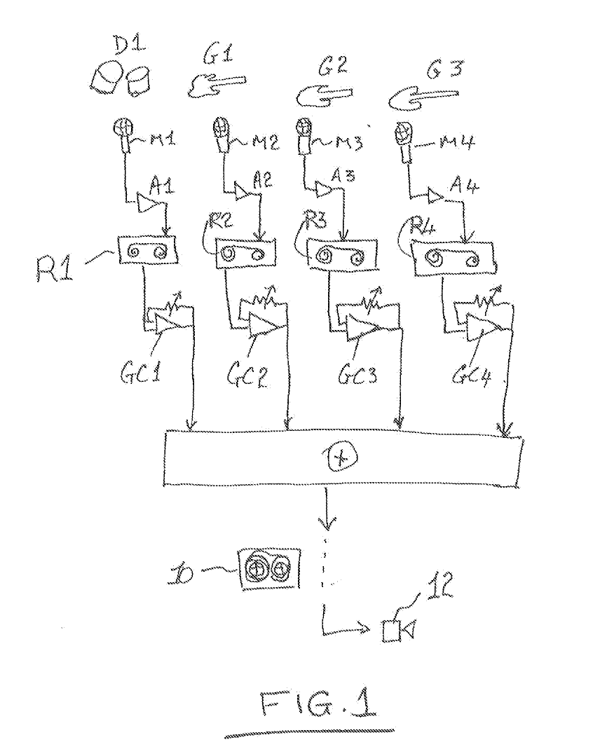

FIG. 1 is a schematic representation of an analogue sound mixing system,

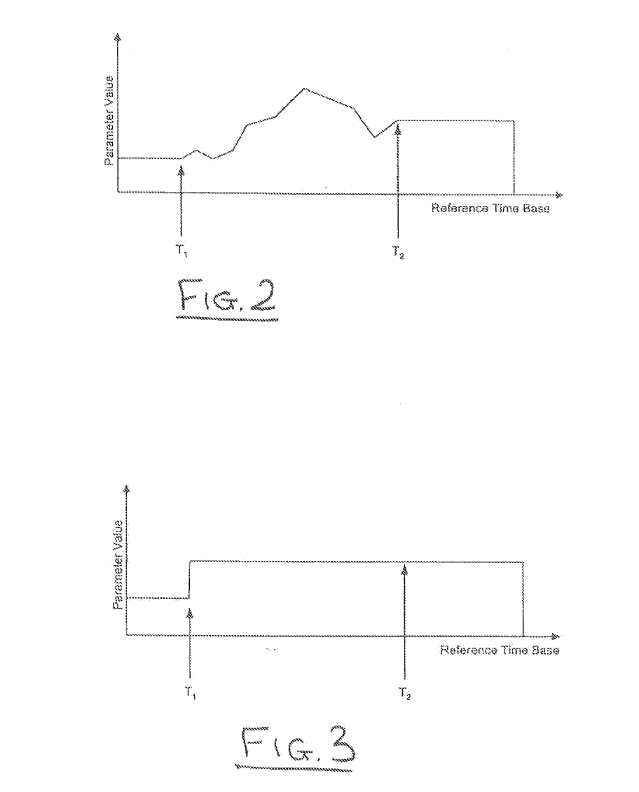

FIG. 2 shows gain value variation during mixing with a sound mixing system,

FIG. 3 shows gain value variation after mixing with a sound mixing system,

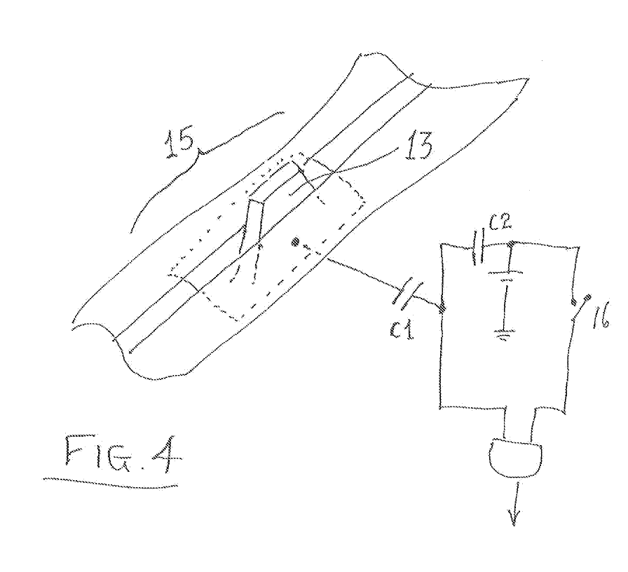

FIG. 4 is a schematic circuit diagram of a detection circuit,

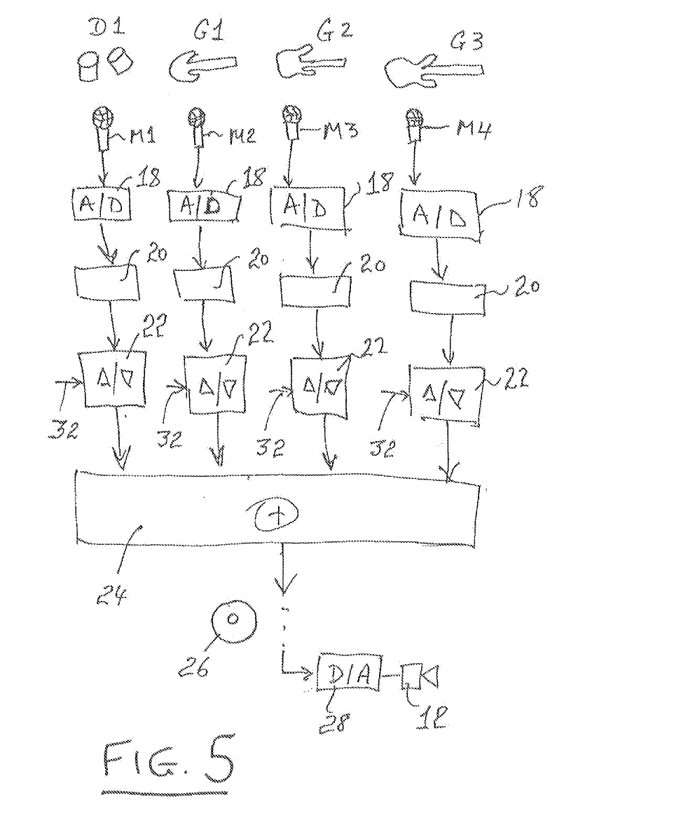

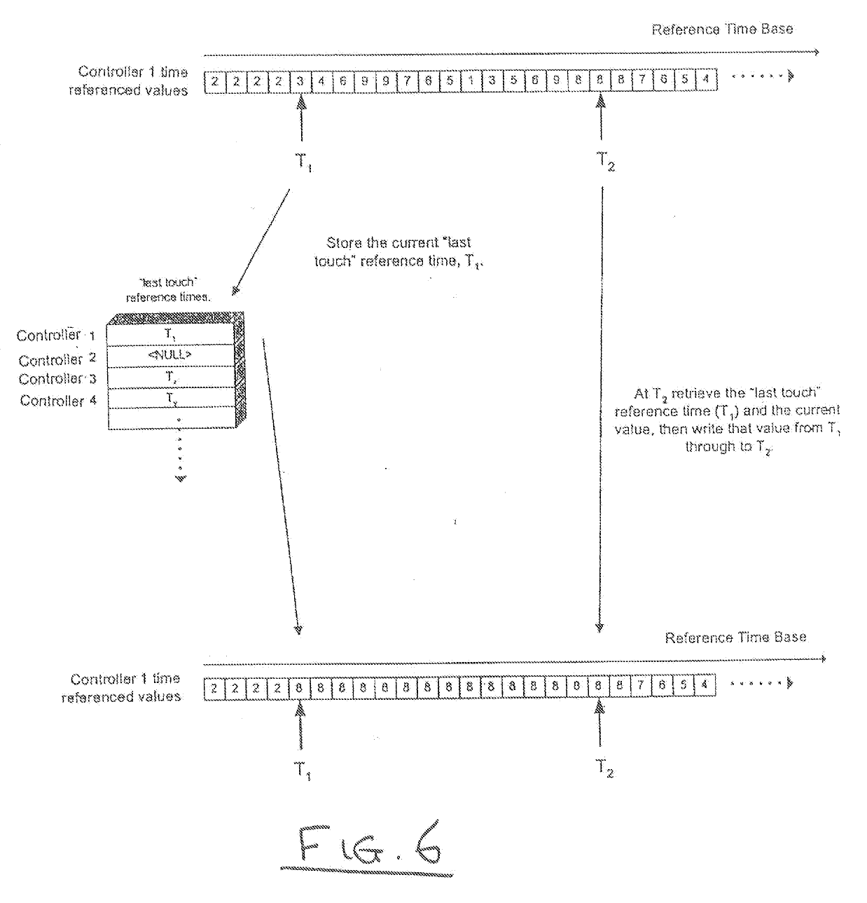

FIG. 5 is a schematic representation of a digital sound mixing system, and

FIG. 6 is a schematic representation of operation of a sound mixing system.

As seen if FIG. 1, a song performed by four artists playing drums D1 and three guitars G1, G2, and G3 is to be recorded. Each artist has a corresponding directional microphone M1-M4 located nearby which picks up predominately the sounds emanating from the corresponding artist. Each microphone has an output signal which is amplified by a corresponding one of four pre-amplifiers A1-A4 before being recorded on a corresponding tape deck R1-R4. After the artists have finished recording, the sound engineer's task begins in order to produce a final recording 10 on a conventional tape cassette which, when playing via a loudspeaker 12, produces the intended final version of the song.

In order to produce the desired final version the sound engineer must adjust the magnitude of each recorded signal from each of the tape decks R1-R4 by means of a corresponding gain controller GC1-GC4 (which it is understood can either amplify or attenuate the record signal). This adjustment in this embodiment is carried out manually by adjusting the position of a slide of an adjustable potentiometer associated with each of the gain controllers GC1-GC4.

Once the sound engineer is satisfied with the adjusted level of the individual recorded signals (which are normally changed in the course of the song), the individual adjusted audio tracks are then essentially added together in a summer 14 to produce the final output which is recorded on the cassette 10.

In this connection it is to be understood that each of the individual tracks recorded by each microphone M1-M4 and subsequently processed can be monoaural, stereo, DOLBY (Registered Trade Mark) or similar signals and the present invention is equally applicable to all such types.

The recorded signals in the tape decks R1-R4 have a common time base with respect to the duration of the intended final recording 10. As explained above, if the sound engineer was not satisfied with the way in which he had manually adjusted the four potentiometer slides during the period 1:34 to 1:45, then it was necessary to stop the mixing procedure, re-wind all the tape decks R1-R4 back to 1:34 and the re-start the tape decks with the potentiometers in the position determined at 1:45. Then the sound mixing continues.

In accordance with the preferred embodiment this re-wind procedure is not required. Instead, the time at which the potentiometer slide was initially touched by the sound engineer (1:34 in this example) is recorded by detecting the initial touch. This is preferably done capacitatively by detecting the discharge of a capacitor C1 (diagrammatically indicated in FIG. 4) when the engineer's finger (and hence his self-capacitance) comes into contact with the metal slide 13 of the potentiometer 15.

In addition, once the sound engineer is satisfied that he has correctly positioned the potentiometer slide 13 to achieve the desired level of gain adjustment, the engineer actuates a switch 16. This actuation takes place at time 1:45 and has the result that the level of gain in the corresponding gain controller is retrospectively adjusted to be that set at 1:45 and applies in the period 1:34 to 1:45, and preferably thereafter, as shown in FIG. 3.

With the above in mind, the digital arrangement illustrated in FIG. 5 can now be considered. As before the four artists play the four instruments in the form of drums D1, and guitars G1-G3. The respective sound outputs are detected by the corresponding microphones M1-M4 and converted into digital signals by four corresponding analogue to digital (A to D) converters. The resulting digital signals are stored in the corresponding one of four digital memory stores 20. This action takes place during the artist's recording session.

Thereafter the sound engineer outputs the stored digital signals into corresponding gain controllers 22 the outputs of which are inputted into a digital summer 24.

As before the output of the summer 24 is the final recording which is stored in a compact disc 26. The signal from the compact disc 26 is passed through a digital to analogue (D-A) converter 28 before being applied to a loudspeaker 12 to re-create the intended song.

Each of the gain controllers 22 has a gain input 32 which is used to set the level of amplification or attenuation of the corresponding gain controller 22. Software control is able to be used to set the gain level of each gain controller 22 for each clock period, or digital time element, which makes up the time base of the digital signals. Thus, when at 1:45 the sound engineer determines the desired gain level, the gain input 32 over the period 1:34 to 1:45 is set to that level, thereby resulting in the desired gain control over that period, as shown in FIG. 6.

If the slide 13 is not touched again then the gain input 32 remain unchanged and the set level of gain continues until the song finishes.

The foregoing describes only one embodiment of the present invention and modifications, obvious to those skilled in the sound recording arts, con be made thereto without departing from the scope of the present invention.

The term “comprising” (and its grammatical variations) as used herein is used in the inclusive sense of “including” or “having” and not in the exclusive sense of “consisting only of”.

1. A method of adjusting the gain applied to an audio track during sound mixing, said method comprising:
(i) at a first time during said track commencing a gain adjustment,
(ii) maintaining a possible gain adjustment until a second time later than said first time and during said track, and
(iii) at said second time triggering a retrospective gain level setting mode, whereby the gain level from said first time to at least said second time is set to the level applying at said second time.

2. A method as claimed in claim 1, wherein said set level applies after said second time.

3. A method as claimed in claim 1, including detecting said first time by detecting the presence of a finger of a sound mixing engineer being applied to a gain adjuster.

4. A method as claimed in claim 3, including detecting said finger presence by detecting a capacitative change.

5. A sound mixing system for adjusting the gain applied to an audio track during sound mixing, said system comprising:
an unadjusted audio track storage section having an output connected to a gain adjuster,
a detector connected with said gain adjuster to detect commencement of gain adjustment at a first time, and to detect maintenance of possible gain adjustment until a second time; and
an actuator operated at said second time and connected with said gain adjuster to retrospectively set the gain thereof to the level applying at said second time from said first time until at least said second time.

6. A system as claimed in claim 5, wherein said gain adjuster when set by said actuator maintains the gain level set at said second time beyond said second time.

7. A system as claimed in claim 5, and having a gain adjusted audio track storage section connected to said gain adjustor to store the gain adjusted audio track.

8. A sound mixing system for adjusting the gain applied to an audio track during sound mixing, said system comprising: an unadjusted audio track storage means having an output connected to a gain adjustment means; detection means connected with said gain adjustment means to detect commencement of gain adjustment at a first time, and to detect maintenance of possible gain adjustment until a second time, actuation means operated at said second time and connected with said gain adjuster to retrospectively set the gain thereof to the level applying at said second time from said first time until at least said second time.

9. A method as claimed in claim 2, including detecting said first time by detecting the presence of a finger of a sound mixing engineer being applied to a gain adjuster.

10. A method as claimed in claim 9, including detecting said finger presence by detecting a capacitative change.

11. A system as claimed in claim 6, and having a gain adjusted audio track storage section connected to said gain adjustor to store the gain adjusted audio track.
